(19) United States
(12) Patent Application Publication
(10) Pub. No.: US 2010/0101575 A1
(43) Pub. Date: Apr. 29, 2010

(54) METHOD AND APPARATUS FOR VENTILATION ASSISTANCE

(76) Inventors: Ludwik Fedorko, Mississauga (CA); Edward Masionis, Toronto (CA)

Correspondence Address: HERMAN & MILLMAN, 55 University Ave, Suite M002, Box 47, TORONTO, ON, M5H 3L5, CA

(21) Appl. No.: 12/519,221

(22) PCT Filed: Dec. 13, 2007
(86) PCT No.: PCT/CA07/02248

§ 371 Date: Dec. 17, 2009

Related U.S. Application Data
(60) Provisional application No. 60/869,726, filed on Dec. 13, 2006.

(51) Int. Cl. A62B 7/10; A62B 18/02; A62B 18/10; A62B 18/08

(52) U.S. Cl. 128/204.21; 128/205.25; 128/205.24

(57) ABSTRACT

A mask interface device is provided for a protective mask of the type having a mask filter and a mask expiratory port, the mask expiratory port having an expiratory port valve of the type that is normally closed and openable upon expiration, the mask filter having an inspiratory air inlet, the mask interface device comprising: a mask interface assembly mountable to the mask and having a mounting interface for mounting an air pressure generator in fluid communication with the inspiratory inlet of the mask filter; and an expiratory port interface assembly mountable to the mask expiratory port and comprising at least one opening for venting expired gas to atmosphere and a one-way valve that is positioned to control the flow of expired gas out through the at least one opening, and wherein the one-way valve is set to an opening pressure that provides positive end expiratory pressure or PEEP. Optionally, this opening pressure is between 2.5 and 20 cm H2O. Optionally, the mask interface device interface directly with the mask filter. In one embodiment of the invention, this interface does not require the filter to have a mating connection and is therefore is universal for a broad class of filters, for example cylindrical filters that project from the mask.

The present invention relates to ventilatory assist devices and more particularly to a lightweight emergency ventilatory assist device that can be retrofitted onto a conventional protective mask without removing the mask, for example, to provide CPAP in situ, i.e. without having to transport the patient to a medical facility.

### BACKGROUND OF THE INVENTION

The ability to immediately treat respiratory distress substantially reduces the number of fatalities sustained during military operations. Civilian emergency medical technologists stress the concept of the “golden hour.” This interval represents the average time that elapses before a patient with serious or multiple injuries will begin to deteriorate rapidly. Without the ability to deliver on-scene medical support, casualties must be transported to a medical facility for treatment. This is often impossible during active operations.

Treatment of these casualties in a nuclear-biological-chemical (NBC) environment is even more difficult. Casualties that occur in an NBC environment that require breathing assistance must be performed with extreme caution so as not to contaminate the casualty or the rescuer. When treating a casualty exposed to a nerve agent, it has been proposed that a cricothyroidotomy is the most practical means of providing an airway for assisted ventilation using a hand-powered ventilator equipped with an NBC filter. As part of that proposed practice, when the casualty reaches a medical treatment facility (MTF) where oxygen and a positive pressure ventilator are available, the hand-powered ventilator and NBC filter are employed continuously until adequate spontaneous respiration is resumed.

Performing a cricothyroidotomy in the field may be difficult during ongoing operations. A method to provide ventilation assistance to a casualty through an existing protective mask may save time and prevent further casualties.

Another situation facing today's Army is a chemical attack on a large group without protective masks in place. This situation may require the ventilation of hundreds of individuals making the large-scale availability of small lightweight, automatic ventilators useful.

While there are several ventilators designed for far-forward medical care, for various reasons these ventilators fall short of what is ideal for first response in the operational environment. For example, some are too heavy to be carried on foot. Some require an external source of pressurized gas or power.

A non-invasive positive pressure respiratory assist device that could be retrofitted onto a protective mask by the patient or another individual without medical training would provide optimize the resources that are available to attend to casualties in military, civil defense, firefighting and settings of an industrial nature.

### SUMMARY OF THE INVENTION

In one aspect, the invention is directed to a mask interface device for a protective mask of the type having a mask filter and a mask expiratory port, the mask expiratory port having an expiratory port valve of the type that is normally closed and openable upon expiration, the mask filter having an inspiratory air inlet, the mask interface device comprising: a mask interface assembly mountable to the mask and having a mounting interface for mounting an air pressure generator in fluid communication with the inspiratory inlet of the mask filter; and an expiratory port interface assembly mountable to the mask expiratory port and comprising at least one opening for venting expired gas to atmosphere and a one-way valve that is positioned to control the flow of expired gas out through the at least one opening, and wherein the one-way valve is set to an opening pressure that provides positive end expiratory pressure or PEEP. Optionally, this opening pressure is between 2.5 and 20 cm H₂O. Optionally, the mask interface device interfaces directly with the mask filter. In one embodiment of the invention, this interface does not require the filter to have a mating connection and is therefore is universal for a broad class of filters, for example cylindrical filters that project from the mask. Such a cylindrical filter may be of known dimension and other characteristics that may serve as a standard to which a mask interface assembly may be designed. For the sake of convenience, filters serving as a basis for design of the mask interface assembly may be referred to herein as universal filters.

The invention is also directed to a kit comprising a mask interface assembly and an expiratory port interface assembly. Optionally the kit includes a case sized to include both the mask interface assembly and an expiratory port interface assembly. Optionally the case comprises a belt clip. Optionally the mask interface device comprises an air-pressure measuring device. Optionally, the mask interface device or kit comprises an air pressure generator.

In another aspect, the invention is directed to a mask interface device for a protective mask of the type having a mask expiratory port, the mask expiratory port having an expiratory port valve of the type that is normally closed and openable upon expiration at an expiratory port valve opening pressure, the mask interface device comprising an expiratory port interface assembly mountable to the mask expiratory port and comprising at least one opening for venting expired gas to atmosphere and a one-way valve that is positioned to control the flow of expired gas out through the at least one opening, and wherein the way valve is set to an opening pressure that provides positive end expiratory pressure or PEEP. Preferably, the opening pressure of the one-way valve is set or settable to a value greater than the expiratory port valve opening pressure. Preferably, the opening pressure of the one-way valve is set or settable to a value that is less than the intra-mask pressure generated by an air pressure generator. Optionally, the mask interface device comprises or is fluidically connectable to an air-pressure measuring device. The air-pressure measuring device may alternatively be configured to sealably mate with the drinking port of the protective mask. Optionally, the mask interface device includes a pressure-relaying interface associated with an air-pressure measuring device, for example air sampling port that is positioned to enable the pressure of gas exiting the expiratory port valve to be measured. The invention is also directed to a kit comprising a mask interface device the mask interface device comprising an expiratory port interface assembly mountable to the mask expiratory port and comprising at least one opening for venting expired gas to atmosphere and a one-way valve that is positioned to control the flow of expired gas out through the at least one opening, and wherein the way valve that is set to an opening pressure that provides positive end expiratory pressure or PEEP. Optionally the kit comprises an air-pressure measuring device. Optionally, the kit further includes a mask interface assembly as define above. Optionally, this mask interface assembly comprises an air pressure generator that is set or settable to control the intra-mask pressure in response to pressure measured by the air-pressure measuring device.

In another aspect, the invention is directed to a mask interface device for a protective mask of the type having a mask expiratory port, the mask expiratory port having an expiratory port valve of the type that is normally closed and openable upon expiration at an opening pressure that provides positive end expiratory pressure, the mask interface device comprising an expiratory port interface assembly mountable to the mask expiratory port and comprising at least one opening for venting expired gas to atmosphere, a one-way valve that is positioned to control the flow of expired gas out through the at least one opening, and an air-pressure measuring device or a pressure-relaying interface (that is associated with an air pressure measuring device, for example air sampling port), that is positioned to measure the pressure of gas exiting the expiratory port valve, and wherein the one-way valve that is set to open at an opening pressure that is greater than the expiratory port valve opening pressure. Preferably, the opening pressure of the one-way valve is set or settable to a value that is less than the intra-mask pressure generated by an air pressure generator. The invention is also directed to a kit comprising the latter mask interface device. The term “air pressure measuring device” may be used for convenience to refer a port or other interface for such a device, and is not meant to imply that the device is physically located in or outside the expiratory port valve so as long as it is operatively associated with the valve to measure pressure of gas exiting the valve. The foregoing notwithstanding that the disclosure may in other instances explicitly refer to the device as being operatively associated with the valve.

In one aspect, the invention is directed to a mask interface device for a protective mask of the type having a mask filter and a mask expiratory port, the mask expiratory port having an expiratory port valve of the type that is normally closed and openable upon expiration, the mask filter having an inspiratory air inlet, the mask interface device comprising an air pressure generating assembly having a an air pressure generator in fluid communication with the inspiratory inlet of the mask filter and an expiratory port interface assembly mountable to the mask expiratory port and comprising at least one opening for venting expired gas to atmosphere, one-way valve that is positioned to control the flow of expired gas out through the at least one opening and an air-pressure measuring device or a pressure-relaying interface (that is associated with an air pressure measuring device, for example air sampling port), that is positioned to enable the pressure of gas exiting the expiratory port valve to be measured, and wherein the way valve that is set to open at an opening pressure that is equal to or greater than the expiratory port valve opening pressure. Optionally, the aforesaid device further comprises a controller for controlling the output pressure of the air-pressure generating device in response to pressure measured by the air-pressure measuring device.

A variety of technologies for measuring pressure are well known to those skilled in the art including pressure transducers and sensors having an air sampling port.

Optionally, the air pressure generator optionally included within the aforementioned mask interface devices or kits are electrically powered and the mask interface device or kit comprises a controller connectable to the pressure sensor to receive pressure measurement output and operatively connectable to the air pressure generator to achieve a selected mask air pressure in response to output of the pressure sensor. Optionally the air pressure generator is a blower powered by a motor and the controller controls the motor speed. Optionally, the blower is a radial blower having a low rotational mass for power efficiency. Optionally the expiratory port interface device is operatively connected to a one-way valve that is set to an opening pressure that provides positive end expiratory pressure or PEEP. Optionally this valve is a mechanical valve that opens at more than one selected pressure. Optionally this valve is microprocessor controllable to achieve a variety of opening pressures. Optionally the motor controller is set to maintain a mask pressure that equals or exceeds the opening pressure of this valve at any given time. Optionally, the expiratory port interface assembly is mountable to the mask to create a chamber at least partially defined by the said mask expiratory port valve and the one-way valve and wherein said chamber is fluidly connected with the pressure sensor. Optionally, the air pressure generator assembly is secured to the mask filter with a rollable resilient sleeve. Optionally, the rollable resilient sleeve includes a lip portion at one end upon which the sleeve may be rolled. Optionally, the sleeve is capable of being annularly mounted on a receptacle portion of the assembly, the receptacle portion of the assembly having a mouth portion for receiving the filter. Further aspects and embodiments of the invention pertaining to the sleeve will be discussed below.

According to another aspect of the invention, the invention is directed to a mask interface device comprising:

a filter receptacle, the filter receptacle having a mouth portion for receiving a filter;

a rollable sleeve of elastic material; and

a coupling interface for a respiratory device, the coupling interface defining an aperture to establish a fluidic communication between the respiratory device and the cylindrical filter and adapted to position the respiratory device in fluid communication with the filter. In one embodiment, the mask is a protective mask. In one embodiment the filter is a cylindrical filter dimensioned to a standard. In another embodiment the mask is pneumatically sealable around the face or head of the user to prevent contaminants form entering the mask.

The inventions is also directed to a kit comprising the protective mask interface device.

As used herein the term fluid or fluidic communication and similar terms refer to a pneumatically efficient communication to prevent substantial loss of airflow continuity and where air pressure is concerned to prevent a substantial loss of air pressure. What may be substantial in one type of application may not be in another. The term fluid communication is used distinctly from a sealed communication that is required to prevent noxious elements from entering the mask. The rolled sleeve of resilient material may be adapted for both fluid and sealed types of types communication, though the context in which it is used may not require the latter type of communication. The term respiratory device is used broadly to refer to any device that would be useful for coupling with a mask and mask filter including an additional filter, an air pressure generator, a source of oxygen etc. The air pressure generator may of the type that is manually operable to generate pressure or a source of compressed air. Optionally the protective mask filter interface device of the invention is coupled to an electrically powered air pressure generator. Optionally this device is included in a kit with an expiratory port interface assembly as generally defined herein with optional fluidic connection to a pressure sensor. Optionally, the kit further comprises one more of parts 100, 300 and 400 (400, if the device includes a pressure sensor and the pressure sensor is not in the expiratory port interface assembly) as described hereafter. Optionally, the protective mask interface is fluidically connected to a blower. Optionally this latter device has any one or more of the features of the air pressure generator assembly defined above and hereinafter.

Optionally, the rollable sleeve of elastic material includes circular lip. Optionally the lip is approximately 0.25 inches in diameter. Optionally the intended lip portion is integrally formed with the sleeve, loosely rolled on itself, at one end, and glued to form the lip diameter. Optionally the sleeve is positionable in relation to the receptacle so as to free the mouth of the receptacle to receive the mask filter. To this end, the receptacle optionally comprises an annular indent portion to seat the sleeve in a rolled position proximal to the mouth of the receptacle. This annular indent serves as one type of means to resist inadvertent unrolling. Such “unroll resistor” may take a variety of forms and the may comprise one or more devices such as fasteners for example a Velcro type fastener. The annular groove may be of smaller diameter than the widest diameter of the receptacle. Optionally the receptacle slopes to a smaller diameter at its mouth in order to enable the cuff to be rolled quickly over the first portion of the mask filter so that it is quickly held in place while it is fully unrolled. Another form of unroll resistor may be an annular bead of wider diameter than the point of attachment of the sleeve so as to provide a cuff retaining hump.

A variety of different sleeve materials of a circumferentially stretchable and optionally noxious resistant nature are well known to those skilled in the art. For example a suitable material is a neoprene covered latex material. This material may be cotton-flocked. This material may have a thickness of approximately 30 mils and may be sized to stretch circumferentially to a diameter 10-25% (optionally between 10 and 15%) greater than its resting diameter in order to form a tight fit over the mask filter. The lip may be formed to have a smaller diameter than the rest of the sleeve (for example 5% smaller). Optionally the length of the sleeve is such that the sleeve, when fully unrolled, positions the lip within a smaller diameter, for example in an indent or optionally behind the mask filter, for example, in the space between the cartridge and the mask.

In another aspect, the invention is directed to mask interface device for a protective mask of the type having a mask filter and a mask expiratory port, the mask filter having an inspiratory air inlet, the mask expiratory port having an expiratory port valve of the type that is normally closed and openable upon expiration, wherein the expiratory port valve is openable at an expiratory port valve pressure, the device comprising:

an air pressure generator assembly mountable to the mask in fluid communication with the inspiratory inlet of the mask filter, the air pressure generator assembly including an air pressure generator that is controllable to generate pressurized air at a selected mask air pressure;

an expiratory port interface assembly comprising at least one opening for venting expired gas to atmosphere and a one-way valve that is positioned to control the flow of expired gas out through the at least one opening, wherein the one-way valve is openable at least one selected valve pressure in response to the flow of expired gas out of the mask expiratory port valve, and wherein the at least one selected valve pressure is preferably greater than the expiratory port valve pressure;

a pressure measurement device;

a controller connected to the pressure measurement device to receive pressure measurement device output and operatively connected to the air pressure generator to regulate the air pressure generated by the air pressure generator to achieve the selected mask air pressure in response to output of the pressure measurement device wherein the selected mask air pressure matches a selected valve pressure;

and wherein the expiratory port interface assembly is mountable to the mask to create a chamber at least partially defined by the said mask expiratory port valve and the one-way valve and wherein said chamber is fluidly connected with the pressure measurement device. The term “matches” means that the selected pressure generated by the air pressure generator equals or is greater than the selected opening pressure of the one-way valve. It is to be understood that the mask interface device is adapted to create a biased unidirectional air into the mask and then out the mask expiratory port valve and through the one-way valve to atmosphere. Optionally, the mask pressure is set to a value that is only slightly greater that the opening pressure of the one way valve so as to maintain flow which maintains the mask expiratory valve sufficiently open to equilibrate the pressure between the mask and chamber or closed volume but otherwise not greater so as to preserve battery power. This flow is generated by the air pressure generator at a target mask pressure that is required for the type of ventilatory support required by the user of the mask and is concomitantly set to maintain the expiratory port valve open almost continuously (except upon sudden inspiration) so that pressure sensor substantially measures the pressure in the mask. Accordingly, the term “closed volume” means a space downstream of the expiratory port valve in fluid communication with the pressure sensor which preferably has a pressure virtually always substantially equilibrated with that of the mask. To accomplish this end this chamber does not need to be sealed and some air escape, for example, through an unsealed one-way valve, serves to maintain a biased airflow that keeps the expiratory port assembly free of contaminants.

As described above, the expiratory port assembly valve is preferably set at or adjustable to a pressure value that provides positive end expiratory pressure (PEEP). Optionally, the expiratory assembly valve sees atmospheric pressure and provides the selected PEEP value at different atmospheric pressures. Optionally, the selected PEEP value is approximately 10 cm H₂O. Optionally, the expiratory port interface assembly includes a locking mechanism for securing it to the mask expiratory port. Optionally, the locking mechanism is of a type that is engaged after the expiratory port interface assembly is finally positioned on the mask expiratory port. Optionally, the locking mechanism comprises a slidable ring that slidably engages a sleeve shaped clamp (mounted over the mask expiratory port) by way of cam action.

According to one aspect of the invention, the air pressure generator creates a biased airflow within the expiratory port assembly such that the expiratory port valve (which may be of the type that normally requires minimal pressure to open) is now “normally” continuously biased into an open position (normally in this case meaning except upon occasional sudden deep inspiration, which only for a short duration desirably closes the mask expiratory port valve to prevent contamination of the interior of the mask) and therefore the pressure sensor is normally measuring the pressure in the mask. Normally, the biased airflow prevents the interior of the mask from contamination. Optionally, the PEEP valve is not sealed and constantly leaks air to enhance the biased airflow.

The mask interface device of the invention may be used to provide a variety of types of respiratory support, for example pressure cycled types of support such as such as CPAP (typical target mask pressure range: 0-15 cm H₂O, typical PEEP setting range: 2.5 to 12.5 cm H₂O), bi-level CPAP (BiPAP), controlled ventilation and assist control ventilation (typical target mask pressure range: on inspiration 0-40 cm H₂O, on expiration: 0-15 cm H₂O, typical PEEP inspiratory setting range: 10 to 40 cm H₂O, typical PEEP expiratory setting range: 0 to 15 cm H₂O), pressure support (typical target mask pressure range: on inspiration 0-40 cm H₂O, on expiration: 0-15 cm H₂O, typical PEEP setting range: 5 to 15 cm H₂O, and proportional pressure support (typical target mask pressure range: on inspiration 0-40 cm H₂O, on expiration: 0-15 cm H₂O, typical PEEP setting range: 5 to 20 cm H₂O) and volume cycled types of support such as controlled ventilation, assist control ventilation and proportional volume ventilation (bellows fill to a volume set mechanically and then empty—typical volume range: 0-1000 cc, typical PEEP setting range: 2.5 to 15 cm H₂O). For the sake of convenience, the ventilating pressure (irrespective of value) generated in the mask by the pressure generator will be referred to as a “controlled intra-mask pressure”.

For controlled ventilation, the microprocessor controller may use a closed loop feedback loop to adjust blower speed to change airway flow (or rate of bellows movement) at a prescribed rate to achieve a target volume in a targeted time period and then may release pressure via PEEP for expiratory time and then repeat the cycle. The microprocessor would provide the required timing and monitor pressure to warn or release pressure if thresholds are exceeded. The motor may of a type capable to deliver 60 LPM at the maximum required peak pressure setting plus accommodate a pressure drop from dirty filter at nominal 12 VDC. An 18 VDC battery provides room for overdriving on a nominal 16-18 VDC to ramp up speeds quickly. Similar in most respects, but by way of contrast, for assist control ventilation inhalation is timed to match patient respiratory rate unless it falls below a preset minimum rate. In the case of proportional volume ventilation, a respiratory effort sensor may be used to determine what pressure to use.

Depending on the type of support provided, other types of sensors and measurement devices may be useful, for example, those that measure for in-flow and out-flow, airway pressure, airflow, time and respiratory effort such as diaphragm EMG and phrenic nerve discharge.

Depending on the type of support provided, other type of expiratory port interface assembly valves may be preferred. For example, for BiPAP a preferred valve would be a mechanical pressure relief valve with precalibrated settings adjusted between 2 levels by a motor or other actuator.

Medical indications for ventilatory support are well known to those medically skilled in the various military, industrial, firefighting, aviation and oil and other mining arts. In military settings typical indications for ventilatory support include cardiovascular diseases such as pulmonary edema, lung disease such as trauma, bleeding, edema, infection, embolization, aspiration of water or other substances, inhalation injury from toxic gases or heat, and assistance in the case of paralysis, loss of chest wall compliance or increased airway or mask resistance.

According to another aspect, the invention is directed to a method of providing non-invasive positive pressure ventilation in junction with a protective mask of the type having a mask filter and a mask expiratory port, the mask expiratory port having an expiratory port valve of the type that is normally closed and openable upon expiration, the mask filter having an inspiratory air inlet, the method comprising: (a) mounting an air pressure generator (component 1) onto the mask in fluid communication with the inspiratory air inlet of the mask filter and b) mounting an expiratory port interface assembly on to the mask expiratory port, the mask expiratory port interface assembly (component 2) comprising at least one open end for venting expired gas to atmosphere and a one-way valve that is positioned to control the flow of expired gas out through the at least one opening, and wherein the one-way valve is set to an opening pressure that provides positive end expiratory pressure or PEEP.

The air pressure generator and expiratory port interface assembly are mounted synchronously or in sequence. In the latter case, the invention is also directed to performing the last in a series of cooperative sequential steps as described hereafter performed by a single or different entities. Optionally, one of the components may be pre-mounted in the course of manufacture or preparation of the device. Optionally, a subject using wearing the mask mounts both components, optionally when wearing the protective mask. Optionally, the air pressure generator is mounted first and turned on before the expiratory port assembly is mounted. Optionally, the mask is in fluid communication with an air-pressure measuring device. Optionally, the air pressure generator is in fluid communication with a controller that controls the pressure generated by the air-pressure generating device in response to the measurements of the air pressure measuring device. Optionally, the method further comprises a step of measuring air pressure in the mask. Optionally, the method further comprises the step of controlling the air pressure generated by the air-pressure generating device in response to measurements obtained by the air-pressure measuring device.

### BRIEF DESCRIPTION OF THE DRAWINGS

FIG. 1 is a perspective view of a mask interface device of the invention showing the positioning of the mask interface device relative to mask when the user wearing the mask wishes to retrofit the device onto the mask.

FIG. 2 is a sectional view of the mask interface assembly.

FIG. 3 shows a mask interface device of the invention retrofitted on to the mask.

FIG. 4 is an exploded view of the mask interface assembly.

FIG. 5 is another exploded view of the mask interface device assembly showing a different perspective.

FIG. 6 shows a partial sectional view of the mask interface device showing the airflow path through the device.

FIG. 7 is a cross-sectional view of the expiratory port interface assembly.

FIG. 8 is an exploded view of the expiratory port interface assembly.

FIG. 9 is an exploded view of the expiratory port interface assembly in section.

FIGS. 10a and 10b show unlocked and locked perspectives of mask expiratory port interface assembly in relation to the mask.

FIG. 11 is a sectional view of another embodiment of the mask interface device.

### DETAILED DESCRIPTION OF THE INVENTION

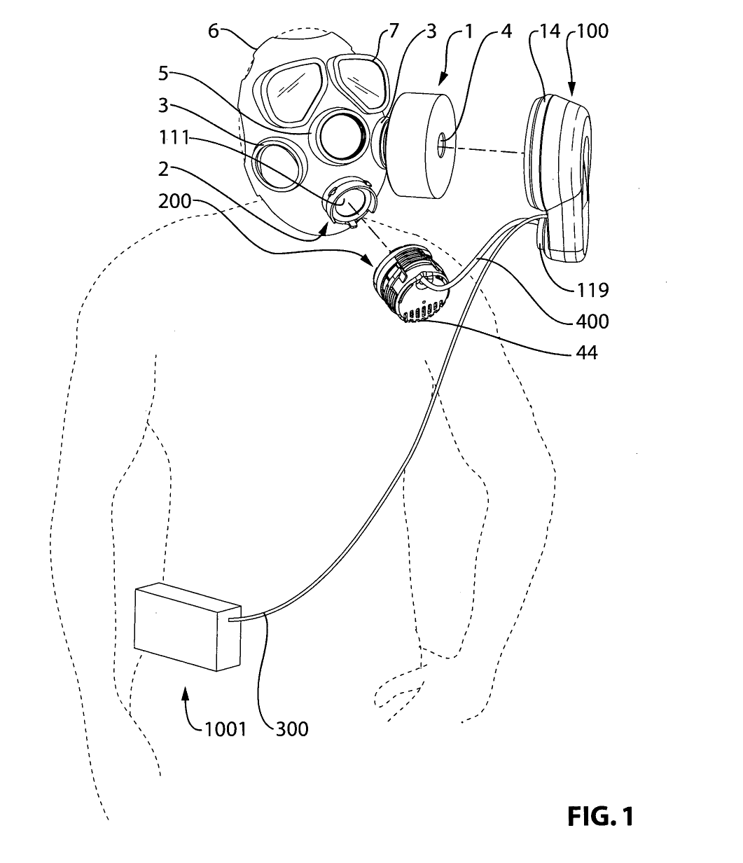

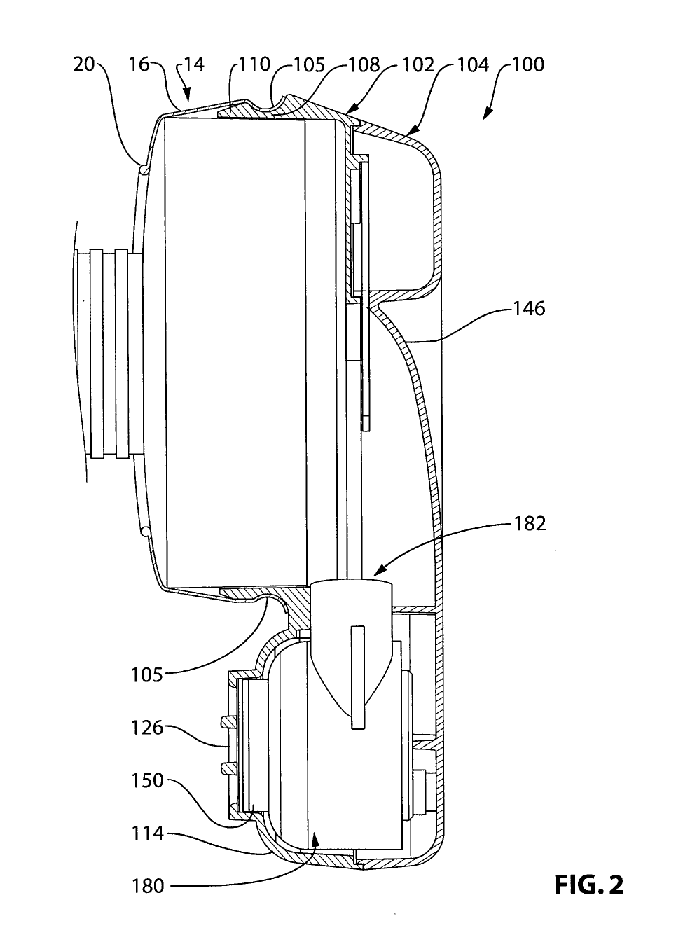

As generally shown in FIG. 1, according to one embodiment of the invention, the mask interface device of the invention may optionally include a mask filter interface assembly 100 and an expiratory port interface assembly 200 which are adapted to fit on to a mask filter 1 and a mask expiratory port 2, respectively. Optionally, the mask filter is of a generally cylindrical shape. Optionally the mask filter is in cartridge form. The term “mask” is used broadly to include a pneumatically isolated (air-pressure retaining) face or head portion of any protective garment or hood that has a cylindrical mask filter. Optionally, the mask may be of the protective type that is pneumatically sealed for preventing inflow of noxious elements. For military applications, the mask is optionally a M40 gas mask outfitted with the NATO C2 cartridge (thread NATO/EN 148-1, 40 mm). Other masks and cartridges are well known to those skilled in the various military, industrial, firefighting, aviation, mining and medical arts (e.g. see http://www.approvedgasmasks.com/). A typical mask 26 to which various embodiments of the invention may be adapted may have left and/or right inspiratory ports 3 to which a mask filter cartridge 1 can be attached. The cartridge 1 is typically mounted by screwing a threaded portion of the cartridge (seen in FIG. 2) into the corresponding threaded portions of the ports 3 (not shown). The mask also typically includes transparent lens elements 7 and a voice communication port 5 and straps 6 which sealably affix the mask to the user's face.

As shown in FIGS. 1 and 2, the mask interface device of the invention includes a mask filter interface assembly 100 that includes an air pressure generating device. Optionally the air pressure generating device requires electrical power to run, for example according to one embodiment of the invention, a motor driven blower 180. The air pressure generator may be powered via a battery pack 1001 associated with an electrical cable 300. Other types of air pressure generators include pumps and sources of compressed air. According to one embodiment of the invention, as shown in the drawings described hereafter, the air pressure generator is a radial blower (for example model U51DX-012KK5 made by Micronel AG which operates at 12 VDC) and the battery pack 1001 that generates sufficient power to power the blower for the application of interest. The battery pack 1001 may be selected to provide excess power, for example, 18 VDC, to power the blower. The blower motor speed may be controlled with pulse width modulated signals and pressure sensor output may be used for closed-loop feedback to maintain a desired output pressure. Pressure settings for continuous positive airway pressure optionally range from 1 to 15 cm H₂O. For example, a target mask pressure setting of 10 cm H₂O with PEEP set at 10 cm H₂O may be preferred for some applications. The blower is preferably able to run continuously at required peak pressure settings as well as accommodate pressure drops from a dirty filter, at nominal 12 VDC. With extra battery power there is room for overdriving on a nominal 16-18 VDC rail to ramp up speeds quickly. The motor may be ramped up to full speed when a pressure drop of any magnitude is ascertained, in order maintain a continuous pressure level in the mask and biased airflow through the mask expiratory port valve 111.

The expiratory port interface optionally includes elements of assembly 200. According to one embodiment of the invention, the expiratory port interface is in fluid communication with a respiratory treatment parameter measuring device, for example a pressure sensor. Suitable pressure sensors include those that measure pressures in the 0-40 cm H₂O range and are well known to those skilled in the art.

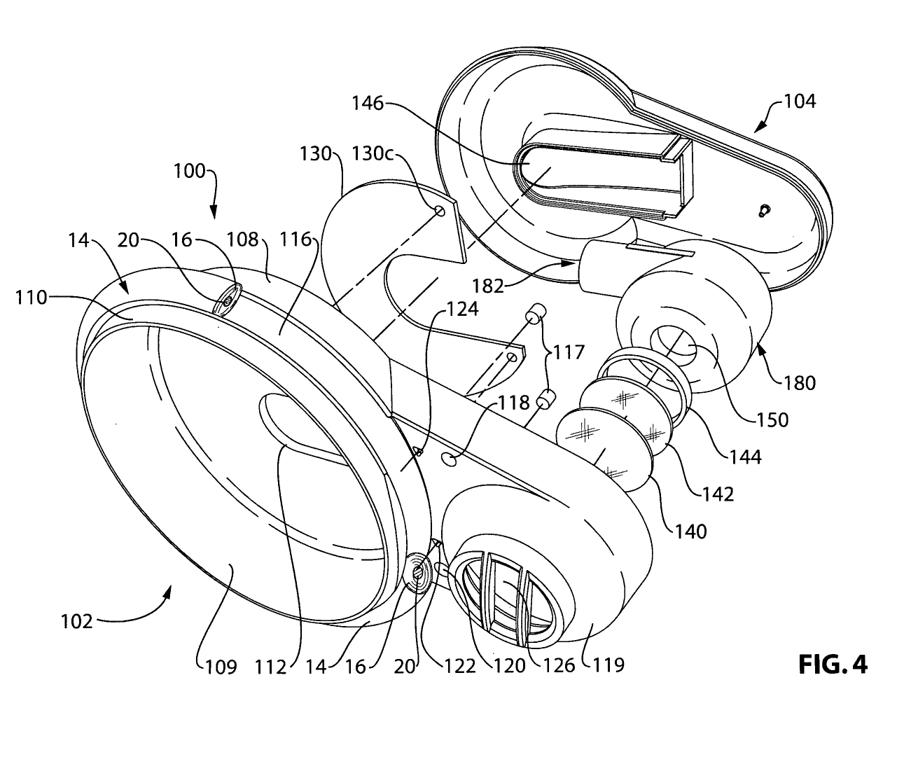

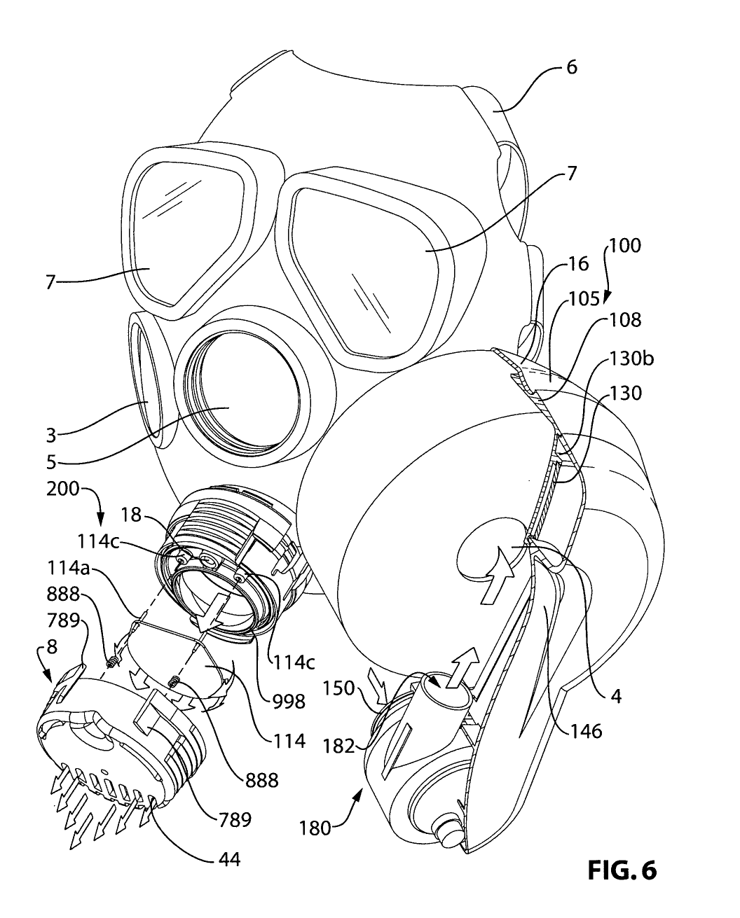

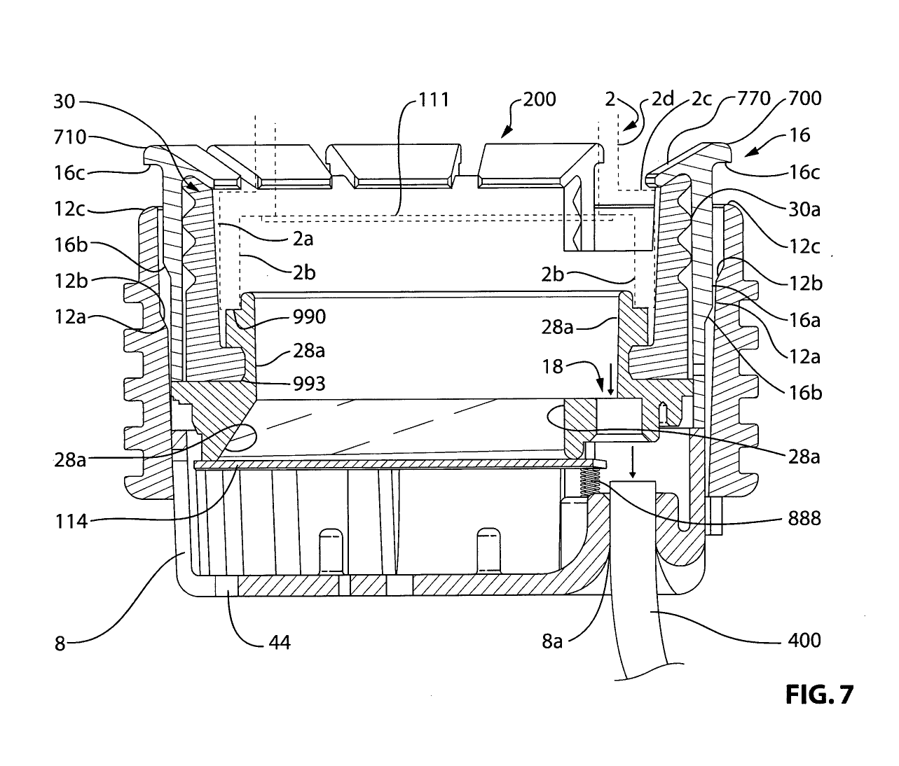

Optionally the pressure sensor may be used to control the pressure generated by the air pressure generator using a feedback control mechanism. Optionally, the pressure sensor 2001 (seen in FIG. 4) is located in proximity to a control board 130 which supports a controller (not shown) that receives output from the pressure sensor 2001 and uses this output to control the pressure applied by the air pressure generator to control the intra-mask air pressure. Optionally, the expiratory port interface assembly includes an air sampling port 18 shown in FIGS. 6 and 7 to sense pressure within the expiratory port interface assembly. The sampling port 18 is optionally in fluid communication via conduit 400 with the pressure sensor, which may be optionally located in the housing of the mask filter interface assembly 100. When the expiratory port interface assembly 200 is secured to the mask expiratory port 3 expired air vents to atmosphere via apertures 44.

As shown in FIGS. 2, 3, 4, 5 and 6 the air pressure generator assembly is fitted with a cuff 14, which includes a sleeve portion 16 rolled around a circular lip portion 20 best shown in FIGS. 2 and 4. When the sleeve portion is snugly rolled around the lip the sleeve may be easily unrolled over the mask filter cartridge.

As shown more particularly in FIG. 2, according to one embodiment of the invention, the mask filter interface assembly 100 may optionally be adapted to receive or house an air pressure generator in the form of a blower 180. The mask filter interface assembly 100 may comprise two primary housing elements 102 and 104. Housing element 102 is the mask filter interface portion of the housing and housing element 104 interfaces with the blower 180. Housing element 102 comprises a receptacle portion 108 for sliding over a mask filter cartridge.

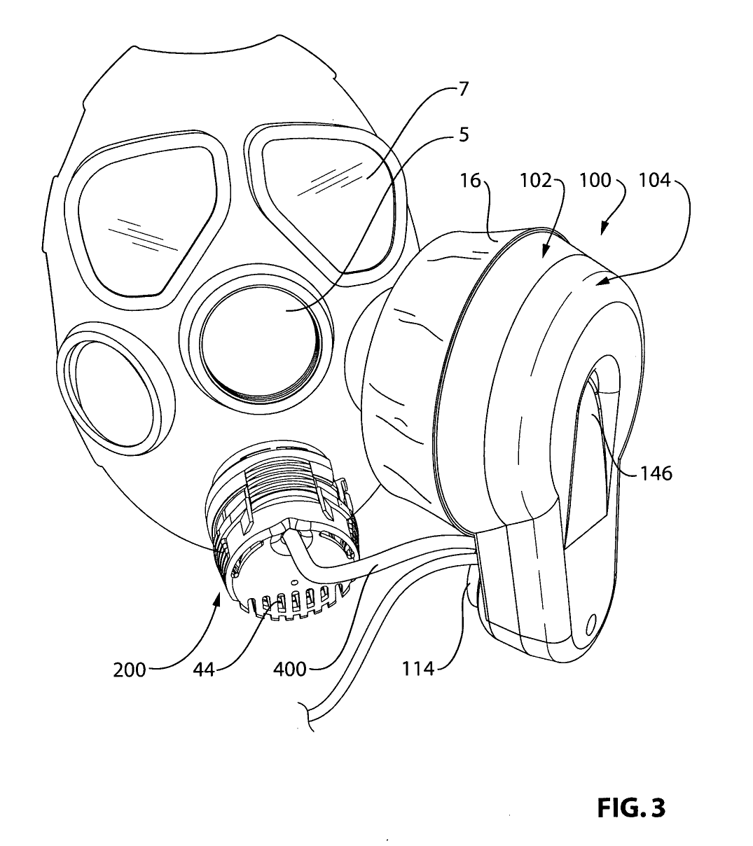

As seen in FIG. 4, 5, and in some respects 6, a u-shaped slot defines air channel portion 112 of the housing 102 and aligns with the air inlet aperture 4 on the mask filter cartridge 1 (see also FIG. 4). Referring also to FIG. 4, housing element 102 also comprises an annular indent portion 116 (best seen in FIGS. 2 and 4), which optionally extends entirely around the receptacle portion 108 of the housing 102, in proximity to the mouth of the receptacle 109 and which optionally serves as both a seat for the cuff 14 and a point of attachment of the free end of the sleeve 105 (for example using a suitable adhesive) opposite the other free end defined by the lip portion 20. Receptacle portion 108 optionally also includes a ramp portion 110 which is of intermediate diameter relative the mask cartridge diameter and the largest diameter of the annular indent portion 116 of the receptacle 108. This ramp portion facilitates rolling the cuff 14 down onto the smaller diameter mask filter cartridge 1. Thus, when a subject wearing the mask positions the mask interface assembly onto the cartridge an initial gripping force is applied to the cartridge to quickly secure its positioning pending complete unrolling of the cuff. As described above, cuff 14 comprises a sleeve portion 16 (best shown in FIG. 3) and a circular lip portion 20, which provides a suitably shaped surface onto which the cuff sleeve 16 may be rolled and unrolled. Housing element 102 further comprises an air inlet portion 119, which is in operative alignment with the air inlet port 150 of the blower 180. The air inlet portion of housing element 119 comprises slot-like apertures 126 which may be integrally formed with this portion of the housing. Filter 140, bolster 142, and spacing ring 144 are generally seated within the cone shaped portion 119 of housing element 102, bolster 142 having a rigid mesh-like constitution serving to support the filter 140.

As shown in FIGS. 2, 4 and 5 housing element 104 comprises an inclined ramp portion 146, which deflects air emerging from the outlet port 182 of the blower so that it deflected through slot 112 and into intake port 4 of the mask filter cartridge 1.

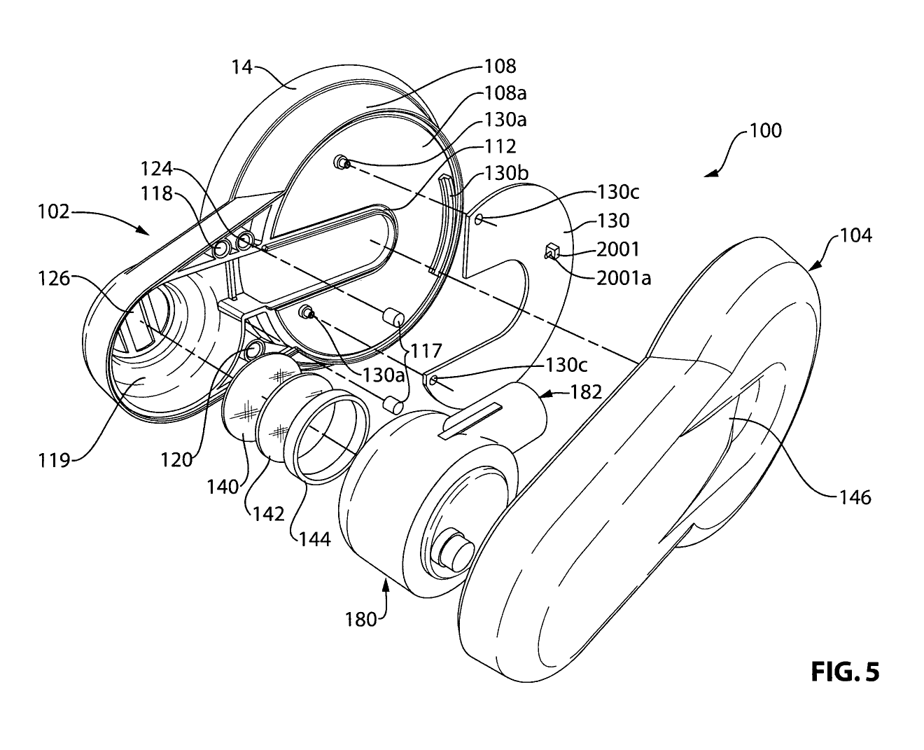

As shown in FIGS. 4 and 5, housing element 102 includes a plurality of smaller ports 118, 120, 122 and 124, respectively. Circular port 118 receives the air-pressure sampling conduit 400 shown in FIGS. 1 and 3 while circular port 120 receives electrical cable 300. The conduit 400 and cable 300 both interface with controller elements in the control board 130. Conduit 400 slides over an air conduit interface port 2001a of a pressure-sensing device 2001 on the control board 130. Triangular reference port 124 is an atmospheric pressure reference port. A conduit (not shown) leads from cylindrical interior portion of this port to a pressure measurement device on the control board 130. By measuring atmospheric pressure and pressure in the mask the controller is able to adjust the speed of the blower motor to maintain a constant or varying desired pressure above atmospheric pressure (as the downstream side of the one way valve in the expiratory port interface assembly sees atmospheric pressure via apertures 44). Triangular port 122 is a vent port for the space containing the control board. This enables pressure to be equalized within this space and atmosphere. Filter elements 117 recessed within ports 122 and 124 prevent the entry debris via these ports. Fastener receptacles 130a and support element 130b support the control board 130 in spaced relation to the back-plate 108a of receptacle 108. Apertures 130c (for receiving fasteners—not shown) the control board 130 interface align with receptacles 130a.

The expiratory port interface assembly is described in detail in FIGS. 6, 7, 8, 9, 10a and 10b.

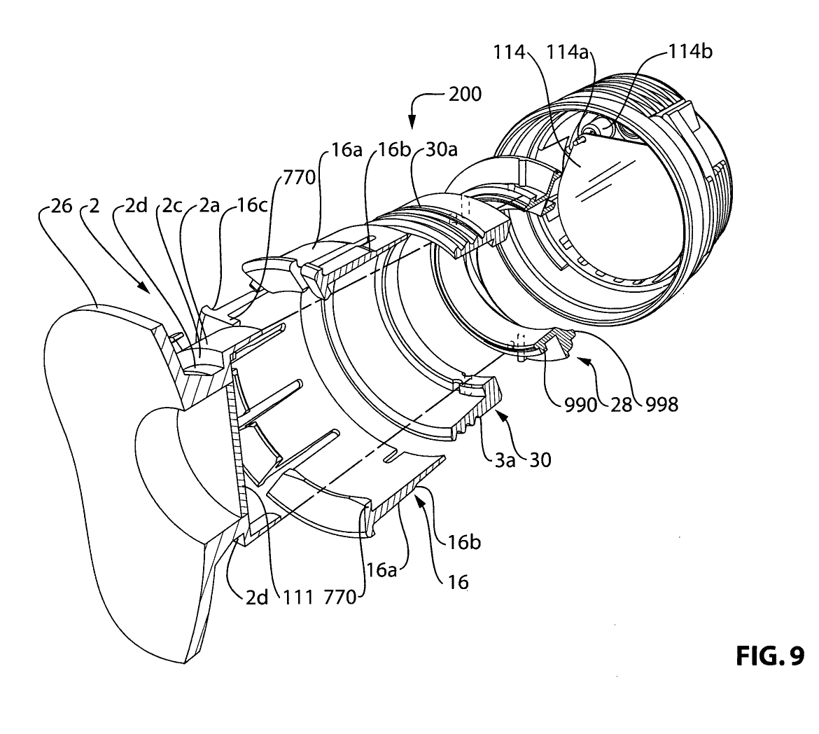

By way of overview, as shown in cross-section in FIGS. 7 and 9, components of the expiratory port interface assembly include toothed gripping element 16, gasket 30 and valve seat element 28, which directly interface with mask expiratory port 2 (shown in FIG. 7 with dotted lines to illustrate the interface).

By way of overview with initial reference to FIG. 6, and then FIGS. 7, 8, 9, 10a and 10b using a one way airflow path from blower air intake port 150→through blower outlet port 182→in filter inlet port 4→out mask expiratory port valve flap 111 (not seen)→out expiratory port interface assembly valve flap 144→out expiratory port interface apertures 44 - - - to provide a directional frame of reference for airflow, valve seat element 28 defines a L-shaped annular seat 993 for gasket 30 on its upstream side and an annular valve seat 998 for compression spring 888 mounted valve flap 144 on its downstream side. Valve flap 114 is exposed to atmospheric pressure via apertures 44 on its downstream side.

More generally, one way expiratory port interface assembly valve (shown as comprising spring elements 888, valve seat 998 and valve flap 144) may be a mushroom valve, a spring actuated valve, a fixed orifice or a leak voltage controlled variable orifice valve. Silicone valves made by liquid injection molding and sold under the trademarks SureFlo and MediFlo are optional alternatives (http://www.Imselastovalves.com/mediflosureflo%20design.htm).

By way of overview, as best shown in FIGS. 7 and 9, when the expiratory port interface assembly 200 is secured onto mask expiratory port 2, the inner walls 2b of mask expiratory port 2, the inner walls 28a of valve seat element 28, the downstream side of mask expiratory port flap 111 and the upstream side of valve flap 144 define, in effect, a closed volume or chamber which is in direct fluid communication with air pressure sampling port 18. The term “closed volume” as used herein refers to a chamber defined in part by an one-way upstream valve (in one embodiment the mask expiratory port valve) that normally seals upon inspiration and a one-way downstream valve (expiratory port interface assembly valve) that is openable in response to at least one set pressure and wherein both valves are biased into a closed position pending creation of a biased airflow (by turning on the blower 180—optionally, after the mask interface assembly is secured and before the expiratory port interface assembly is secured) to establish fluidic continuity between the mask and the otherwise normally closed volume.

As described above, according to one aspect, the invention is directed to a mask interface device which is adapted to provide positive pressure ventilatory assistance with feedback loop pressure control that can be rapidly deployed by an individual in a contaminated environment without removing the mask or compromising its protective structural integrity. Optionally, by creating the chamber as aforesaid which (absent airflow) is biased to be a closed volume and despite the imposed positioning of the air pressure sampling port downstream of the of mask expiratory port flap 111 (so as not compromise the structural integrity of the mask), pressure can be measured in the mask from within the chamber by using the controller to maintain an airflow that biases the mask expiratory port flap 111 and expiratory port interface flap 114 into an open position. This is optionally accomplished by maintaining the mask pressure at a predetermined level that equals or exceeds the opening pressure of flap 114. The continuously biased flow of air prevents contaminants from building up in the transiently closed volume and entering the mask via mask expiratory port flap 111. A suitable biased airflow may be also maintained when closure of the valve flap 114 is unsealed.

By way of overview, the expiratory port assembly 200 also comprises a locking ring 12, which cooperates with toothed gripping element 16 and gasket 30 to secure the expiratory interface assembly 200 to the mask expiratory port.

By way of overview, expiratory port interface assembly 200 also comprises housing element 8 having apertures 44 to vent expired gases to atmosphere, a valve flap 114 upstream thereof and compression springs 888 which maintain the one way valve flap 114 in a closed position unless pressure in the expiratory port interface assembly upstream of the valve exceeds the flap opening pressure (normally when the blower is on due to biased airflow and especially during expiration), as dictated by the springs and atmospheric pressure (seen by the valve flap via apertures 44). Housing element 8 also comprises flanges 789 which define circumferential slots to retain the locking ring 12 for sliding movement over the surface of toothed gripping element 16. Housing element 8 also comprises a port 8a for receiving the conduit 400 and cylindrically shaped receptacles 114b for seating the compression springs 888 and pins 114a. Receptacles 114c (shown in FIG. 6) receive pins 114a on the downstream side of valve seat element 28.

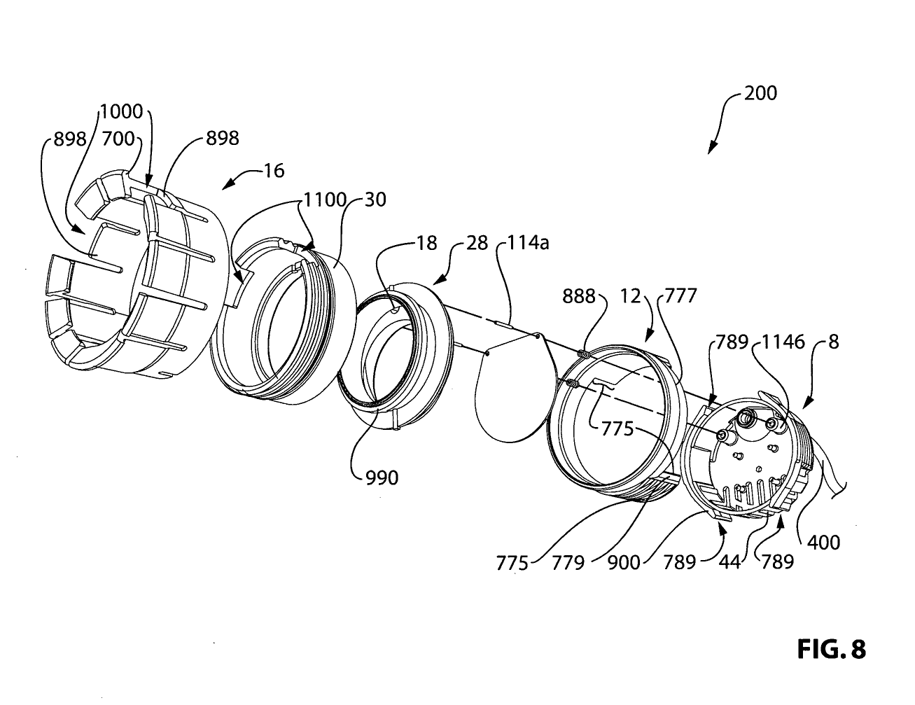

As shown in FIGS. 8 and 9, locking ring 1 comprises a ring portion 777 (shown as spanning the longitudinal distance “B” in FIG. 9) and two longitudinally extended gripping portions 775 (having a ridged surface that allow these portions to be more securely gripped by the thumb and index finger of an operator when used to perform the last (locking) step in securing the expiratory interface assembly 200 to the mask expiratory port 2—gripping portions 775 are shown as spanning the longitudinal distance “A” in FIG. 9). Gripping portions 775 have beveled portions 779 that are retained by a plurality of annular flanges 789 of housing element 8. Beveled portions 779 slidably ride in a longitudinal direction under flanges 789.

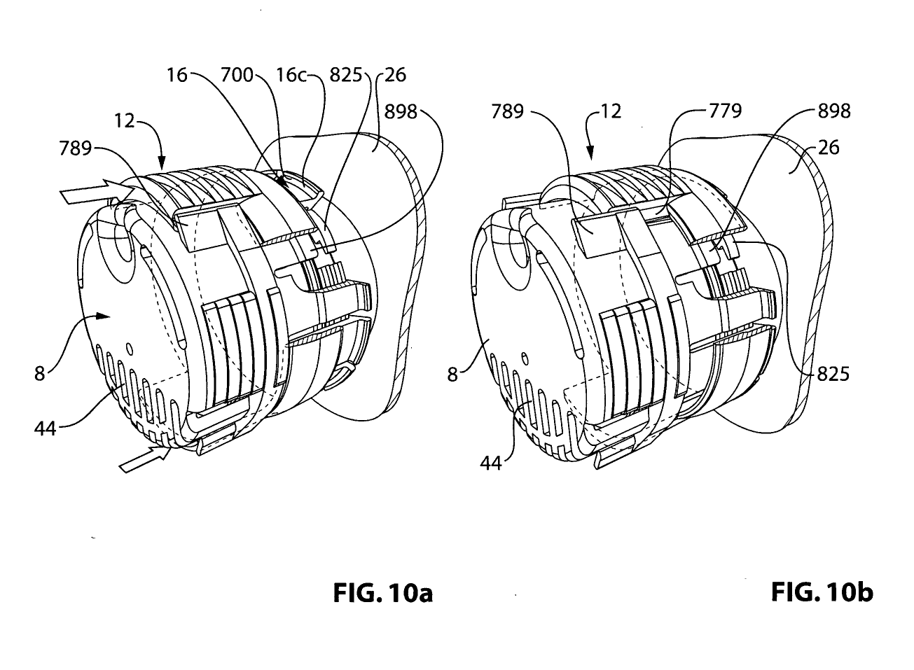

As seen in FIGS. 8, 10a and 10b showing the direction in which the expiratory port interface assembly 200 is moved to slidably engage the mask expiratory port 2, shortened toothless finger-like projections 898 of toothed gripping element 16 define slots 1000 that avoid interference with T-shaped pins 825 (pins that normally support a conventional ‘mask expiratory port cap and drinking port assembly’—not shown) and thereby permit the expiratory port interface assembly 200 to slide fully onto the mask expiratory port 2. The gasket 30 has corresponding slots 1100 for the same purpose. As best shown in cross-section in FIG. 7, annular shoulder 990 of valve seat element 28 serves as a contact surface for contacting the most projecting portion of the mask expiratory port 2 to define this fully mounted position which in turn corresponds with the position in which tooth-like projections 770 can be locked behind surface 2c of the mask expiratory port 2 for securely coupling the expiratory port interface assembly 200 onto the mask expiratory port 2.

As best seen in FIG. 7, cylindrical gasket 30 is pressed into a pneumatically efficient interface with mask expiratory port 2 by finger-like projections of gripping element 16. These finger-like projections are capable of being compressed against the gasket 30 by sliding locking-ring 12 from the an unlocked position (FIG. 10a) in which the surfaces 12a and 16a of the locking ring and finger like projections are not are not engaged to exert a compressing cam action against the finger like projections and a second locked position (FIG. 10b) in which the locking ring is longitudinally displaced towards surfaces 16c of the finger-like projections, these surfaces on the individual finger-like projections collectively defining an annular (the term annular not necessarily implying continuity) ring-retaining lip 700 of the gripping element 16 that projects radially outwardly to retainingly engage abutment surface 12c of the locking ring 12. When the ring is moved from the unlocked position into the locked position beveled cam surfaces 12b and 16b of the locking ring and finger-like projections, respectively, slide past one another to exert a radial compressive force against the circumferential exterior face 16a of the finger-like gripping elements to compress them into closer proximity with one another. This in turn applies corresponding compressive forces respectively against corrugated face 30a of the gasket 30 and face 2a of the mask expiratory port 2. In tandem, the radially inwardly projecting tooth-like portions 770 of the finger-like projections move radially inwardly towards a lesser diameter surface 2d of the mask expiratory port 2, so as to lock these tooth-like portions behind the retaining surface 2c of the mask expiratory port 2.

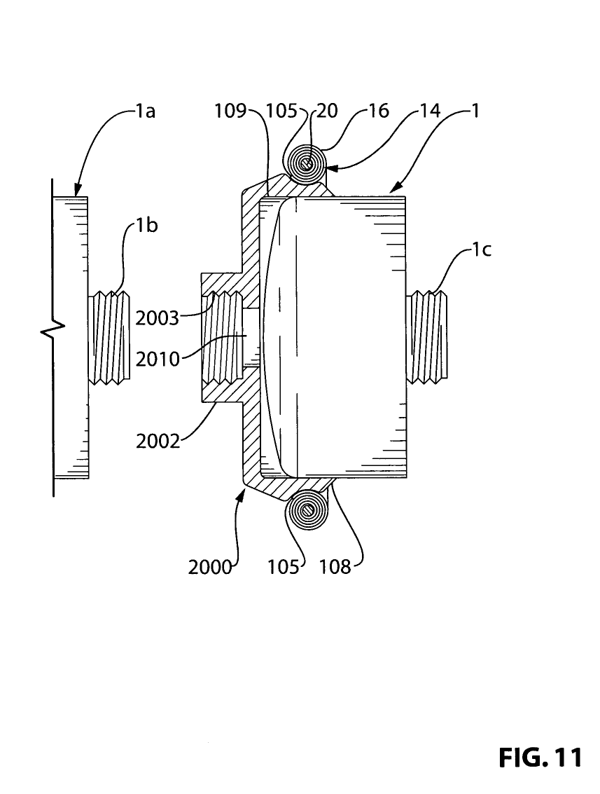

As shown in FIG. 11, in a more general aspect the mask interface device 2000 of the invention may comprise an interface with any respiratory device, for example, any device through which air travels that is functional in conditioning air inspired by the wearer of the mask, the interface, for example, being in the form of port 2002 having a threaded portion 2003 for receiving a second filter 1a fitted with a mating threaded portion 1b. Fluidic communication is established between the filters via port 2010 in the interface device. The threaded portion 2003 of the device and the cuff 14 may be adapted to create a sealed communication between the filters 1 and 1a to prevent noxious elements from entering into the gas mask. The term “air” is used broadly throughout to refer to a gas of any composition pertinent to respiratory assistance, comfort or medical treatment.

We claim:

1. A mask interface device for a protective mask of the type having a mask filter and a mask expiratory port, the mask expiratory port having an expiratory port valve of the type that is normally closed and openable upon expiration, the mask filter having an inspiratory air inlet, the mask interface device comprising:
(a) an air pressure generating assembly comprising an air pressure generator in fluid communication with the inspiratory inlet of the mask filter; and
(b) an expiratory port interface assembly mountable to the mask expiratory port and comprising:
(i) at least one opening for venting expired gas to atmosphere;
(ii) a one-way valve that is positioned to control the flow of expired gas out through the at least one opening; and
(iii) an air-pressure measuring device that is positioned to enable the pressure of gas exiting the expiratory port valve to be measured;
and wherein the one-way valve that is set to open at an opening pressure that is equal to or greater than the expiratory port valve opening pressure.

2. The mask interface device according to claim 1, further comprising a controller for controlling the output pressure of the air-pressure generating device in response to pressure measured by the air-pressure measuring device.

3. The mask interface device according to claim 1, wherein the air pressure generator is electrically powered.

4. The mask interface device according to claim 2, wherein the air pressure generator is a blower powered by a motor and the controller controls the motor speed.

5. The mask interface device according to claim 4, the blower is a radial blower having a low rotational mass for power efficiency.

6. The mask interface device according to claim 1, wherein the one-way valve that is set or adjustable to an opening pressure that provides positive end expiratory pressure or PEEP.

7. The mask interface device of claim 1, wherein the opening pressure of the one-way valve is set or adjustable to a value that is less than a controlled intra-mask pressure.

8. The mask interface device according to claim 2, wherein the controller is programmable or set to maintain a mask pressure that equals or exceeds the opening pressure of the one-way valve.

9. The mask interface device according to claim 1, wherein the expiratory port interface assembly is mountable to the mask to create a chamber at least partially defined by the said mask expiratory port valve and the one-way valve and wherein said chamber is fluidly connected with the pressure sensor.

10. The mask interface device according to claim 1, wherein the air pressure generator assembly is secured to the mask filter with a rollable resilient sleeve.

11. A kit of components of a mask interface device adapted to be used with a protective mask of the type having a mask filter and a mask expiratory port, the mask expiratory port having an expiratory port valve of the type that is normally closed and openable upon expiration, the mask filter having an inspiratory air inlet, the kit comprising a mask interface assembly and an expiratory port interface assembly, the mask interface assembly comprising at least a mounting interface for mounting an air pressure generator to, and in fluid communication with the inspiratory inlet of, a respiratory mask filter; and wherein the expiratory port interface assembly is mountable to the mask expiratory port and comprises:
(i) at least one opening for venting expired gas to atmosphere;
(ii) a one-way valve that is positioned to control the flow of expired gas out through the at least one opening; and
(iii) an air-pressure measuring device that is positioned to enable the pressure of gas exiting the expiratory port valve to be measured;
and wherein the one-way valve is set to open at an opening pressure that is equal to or greater than the expiratory port valve opening pressure.

12. A kit according to claim 11, further comprising a controller for controlling the output pressure of an air-pressure generating device in response to pressure measured by the air-pressure measuring device.

13. A kit according to claim 11 or 12, comprising an electrically powered air pressure generator.

14. A kit according to claim 11, 12 or 13, wherein the air pressure generator is a blower powered by a motor and the controller controls the motor speed.

15. A kit according to claim 14, further comprising a battery pack for supplying power to the blower.

16-21. (canceled)
